(19) United States
(12) Patent Application Publication
(10) Pub. No.: US 2018/0107885 A1
(43) Pub. Date: Apr. 19, 2018

(54) METHOD OF AUTHENTICATING USER USING A PLURALITY OF BIOMETRIC INFORMATION

(71) Applicant: MY DEVICE CO., LTD., Seongnam-si (KR)

(72) Inventors: Yun Seo JO, Yongin-si (KR); Min Ho KIM, Seongnam-si (KR)

(73) Assignee: MY DEVICE CO., LTD., Seongnam-si (KR)

(21) Appl. No.: 15/296,303

(22) Filed: Oct. 18, 2016

(30) Foreign Application Priority Data
Oct. 13, 2016 (KR) 10-2016-0133144
Oct. 13, 2016 (KR) 20-2016-0005919

(51) Int. Cl. G06K 9/00; G06K 9/62; G06K 9/52

(52) U.S. Cl. CPC G06K 9/00892; G06K 9/6215; G06K 9/00617; G06K 9/00087; G06K 9/52

(57) ABSTRACT

According to another aspect of the inventive concept, there is provided a method of authenticating a user using a plurality of biometric information, the method comprising, receiving an input for setting a security level, receiving first biometric information and second biometric information of a user, and comparing at least one of the first biometric information and the second biometric information which corresponds to the security level with pre-registered reference biometric information and accepting to authenticate the user when a similarity score between the at least one of the first biometric information and the second biometric information and the pre-registered reference biometric information is equal to or greater than a preset reference value.

This application claims the benefit of Korean Patent Application Nos. 10-2016-0133144, filed on Oct. 13, 2016, and 20-2016-0005919, filed on Oct. 13, 2016 in the Korean Intellectual Property Office, the disclosures of which are incorporated herein by reference in its entirety.

### BACKGROUND

### 1. Field

The present inventive concept relates to a method of authenticating a user using a plurality of biometric information, and more particularly, to a method of authenticating a user using a plurality of biometric information by varying a reference value according to a security level set by the user or by varying biometric information used to authenticate the user.

### 2. Description of the Related Art

The recent interest and active research into system security are increasing the interest in user authentication day by day.

Of conventional methods of authenticating a user, a method using a password has been most widely used. The password method is a method of authenticating a user using a password input by the user. Here, the password is registered in advance by the user and consists of numbers, letters, or a combination of the numbers and the letters.

Since the password method does not provide high security, there is a risk of harm such as the leakage of personal information. For this reason, a method of authenticating a user using biometric information such as fingerprints and irises which provide higher security has been developed.

Fingerprint recognition is the most widely used biometrics technology. Of biometrics technologies, fingerprint recognition is most simple and inexpensive and has a relatively high recognition rate with an error rate of less than 0.5% and a high verification speed of less than 1 second.

However, since about 5% of the population has damaged fingerprints, user authentication using fingerprints cannot be performed for those people. In addition, if fingerprints remaining on the glass of a fingerprint scanner are copied, the biometric information can be leaked. Also, dirt on the skin can make accurate authentication impossible.

Iris recognition is a method of authenticating a user using patterns in irises. In iris recognition, higher security can be expected because more feature points can be extracted from irises than from fingerprints. However, iris recognition has a significantly low outdoor recognition rate and is hard to be accepted by the public because a scanner should be placed close to a user's eyes.

As described above, the biometrics technologies widely introduced to the public have drawbacks. Therefore, user authentication performed using only one biometrics technology can cause user inconvenience.

Accordingly, there is a need for a new form of user authentication method which can improve user convenience and increase the recognition rate by remedying the drawbacks of the biometrics technologies.

### SUMMARY

Aspects of the inventive concept provide a method of authenticating a user stage by stage using a plurality of pieces of biometric information.

Aspects of the inventive concept also provide a method of authenticating a user using a plurality of pieces of biometric information by varying a security level.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a method of authenticating a user using a plurality of biometric information, the method comprising, receiving an input for setting a security level, setting a first reference value used to determine whether first biometric information of a user matches pre-stored first reference biometric information of the user to a value corresponding to the security level, setting a second reference value used to determine whether second biometric information of the user matches pre-stored second reference biometric information of the user to a value corresponding to the security level, receiving the first biometric information and the second biometric information of the user, and authenticating the user using the similarity between the first biometric information and the first reference biometric information and the similarity between the second biometric information and the second reference biometric information.

According to another aspect of the inventive concept, there is provided a method of authenticating a user using a plurality of biometric information, the method comprising, receiving an input for setting a security level, receiving first biometric information and second biometric information of a user, and comparing at least one of the first biometric information and the second biometric information which corresponds to the security level with pre-registered reference biometric information and accepting to authenticate the user when a similarity score between the at least one of the first biometric information and the second biometric information and the pre-registered reference biometric information is equal to or greater than a preset reference value.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart illustrating a method of authenticating a user using a plurality of biometric information according to an embodiment;

FIG. 2 illustrates a false acceptance ratio (FAR) and a false rejection ratio (FRR);

FIGS. 3 and 4 illustrate a process of setting a first reference value and a second reference value corresponding to a first security level according to an embodiment;

FIGS. 5 and 6 illustrate a process of setting a first reference value and a second reference value corresponding to a second security level according to an embodiment;

FIG. 7 is a flowchart illustrating a method of authenticating a user using a plurality of pieces of biometric information according to an embodiment;

FIG. 8 is a flowchart illustrating a process of authenticating a user using biometric information based on a security level set by a user according to an embodiment; and

FIG. 9 is a functional block diagram of an apparatus for authenticating a user using a plurality of biometric information according to an embodiment.

FIG. 10 illustrates a user authentication apparatus using a plurality of biometric information according to an exemplary embodiment of the present disclosure.

FIGS. 11 and 12 illustrate acquiring multiple biometric information by a user authentication apparatus using a plurality of biometric information according to an exemplary embodiment of the present disclosure.

FIGS. 13 and 14 illustrate a user authentication apparatus using a plurality of biometric information according to another exemplary embodiment of the present disclosure.

FIGS. 15 and 16 illustrate a user authentication apparatus using a plurality of biometric information according to another exemplary embodiment of the present disclosure.

FIG. 17 illustrates a user authentication method according to an exemplary embodiment of the present disclosure, in which a security level is set and biometric information to be used in user authentication is chosen according to the set security level.

### DETAILED DESCRIPTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms used herein are defined as follows.

### Fingerprint Recognition

A technology of verifying the identity of a person based on the fingerprint pattern of the person. Sensors used include an optical or semiconductor sensor for obtaining still fingerprint information and a sensor for obtaining fingerprint information by sliding a finger like sliding a card.

### Iris Recognition

A technology of verifying the identity of a person using various patterns formed in the circular iris located adjacent to the pupil at the front of the eyeball.

### Enrollment

A process of defining biometric information in a biometric system together with a user ID in order for biometric authentication/verification or identification.

### Extraction

A process of obtaining a biometric sample from raw biometric information.

### Matching

A process of measuring the similarity between a feature point extracted from an input biometric information sample and reference biometric information.

### Matching Score

A value indicating the similarity calculated as a result of matching

### Reference Value

A standard used to determine whether input biometric information of a user matches pre-stored reference biometric information of the user.

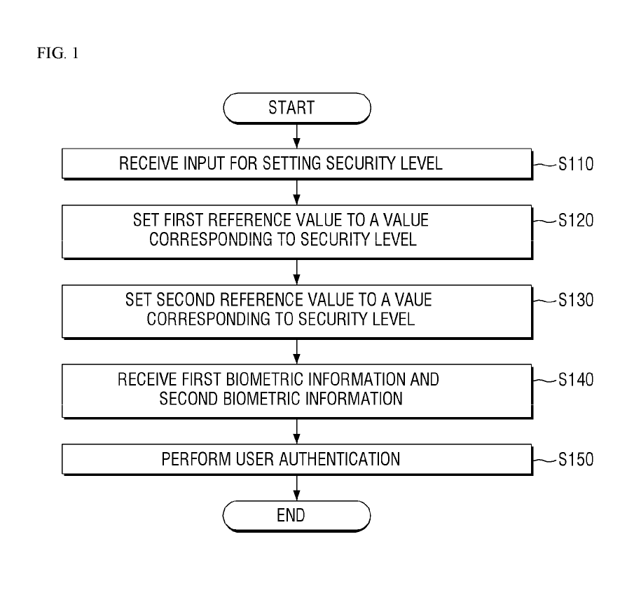

FIG. 1 is a flowchart illustrating a method of authenticating a user using a plurality of biometric information according to an embodiment.

The subject which performs user authentication using a plurality of biometric information according to an embodiment may be an electronic device in which a program or application for performing user authentication is installed. According to an embodiment, the electronic device may be a server to which a plurality of computing devices are coupled, a desktop PC, a tablet PC, a smartphone, etc. The electronic device may also be a general-purpose computing device.

In the method of authenticating a user using a plurality of biometric information, an input for setting a security level is received (operation S110). The term ‘security level” may denote the degree of security set for each piece of content or each transaction that requires user authentication.

For example, the degree of security required in a case where user authentication is needed to log into a specific website may be different from the degree of security required in a case where user authentication is needed to perform electronic commerce in the website after login. Therefore, a manager of the service may set an optimum security level for each transaction.

An unnecessarily high security level may increase a false rejection ratio (FRR), and the increased FRR may reduce a recognition rate, causing inconvenience to users. On the other hand, a security level lower than required may increase a false acceptance ratio (FAR). Therefore, when an unauthenticated user's fingerprint is input, it can be wrongly determined to be an authenticated user's fingerprint. The FRR and the FAR will be described in greater detail later.

Once the security level is set, a first reference value used to determine whether first biometric information of a user matches pre-stored first reference biometric information of the user is set to a value corresponding to the security level (operation S120). In the user authentication method according to the embodiment, a plurality of biometric information is used. Therefore, a second reference value used to determine whether second biometric information of the user matches pre-stored second reference biometric information of the user is set to a value corresponding to the security level (operation S130).

Then, the first biometric information and the second biometric information of the user are received (operation S140). The first biometric information and the second biometric information of the user may be received through sensors included in a computing device which performs the user authentication method.

For example, if the first biometric information is fingerprint information of the user and the second biometric information is iris information of the user, the first biometric information may be received through a sensor which scans fingerprints, and the second biometric information may be received through a sensor which captures images of irises. The first biometric information and the second biometric information may be received at the same time or at different times.

Next, the user is authenticated using the similarity between the first biometric information and the pre-stored first reference biometric information and the similarity between the second biometric information and the pre-stored second reference biometric information (operation S150).

Here, the reference biometric information may be biometric information registered in advance by the user in order for user authentication. For example, if the first biometric information is the user's fingerprint information and the second biometric information is the user's iris information, the first reference biometric information may be the user's fingerprint registered in advance by the user, and the second reference biometric information may be the user's iris information registered in advance by the user.

According to an embodiment, the reference biometric information may be stored together with an identifier such as an ID used to identify the user.

Prior to specifically describing the method of authenticating a user using a plurality of biometric information, the FAR and the FRR will be described.

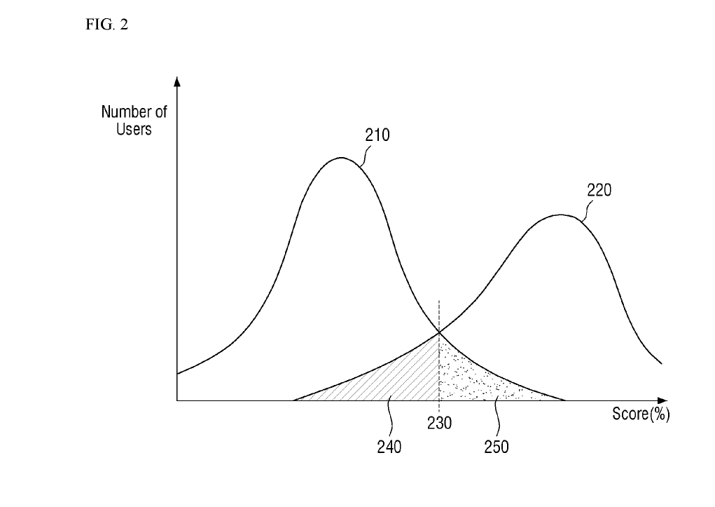

FIG. 2 illustrates the FAR and the FRR.

In user authentication performed using biometric information such as fingerprints or irises, feature points of the biometric information are used. The similarity distribution of feature points in feature point-based biometric information authentication takes the form illustrated in FIG. 2.

Referring to the graph of FIG. 2, the x-axis represents the matching score indicating the similarity between a feature point extracted from an input biometric information sample and a feature point of pre-registered reference biometric information, and the y-axis represents the number of users having the similarity.

Here, a first graph 210 represents the distribution of matching scores of biometric information which does not match the pre-registered reference biometric information, and a second graph 220 represents the distribution of matching scores of biometric information which matches the pre-registered reference biometric information.

In addition, a reference value 230 is a matching score used to determine whether input sample information matches the pre-registered reference biometric information.

If a matching score indicating the similarity between feature points is used to determine whether input biometric information matches the pre-registered reference biometric information, an overlapping area inevitably exists between the first graph 210 and the second graph 220 as illustrated in FIG. 2, resulting in an error.

For example, in a first area 240 located on the left side of the reference value 230 of FIG. 2, the similarity between the pre-registered reference biometric information and input biometric information is lower than the reference value 230. Therefore, even if the pre-registered reference biometric information and the input biometric information are from the same user, the input biometric information can be determined to be not the biometric information of the user. This is called the FRR.

On the other hand, in a second area 250 located on the right side of the reference value 230, the similarity between the pre-registered reference biometric information and input biometric information is higher than the reference value 230. Therefore, even if the input biometric information is from a different user, it can be determined to be the biometric information of the user. This is called the FAR.

Although user authentication using biometric information is performed primarily for security, a high FAR as illustrated in FIG. 2 can lead to detrimental results.

However, if the reference value 230 is shifted to the right in the graph of FIG. 2 in order to increase security, the FRR is increased, thus causing inconvenience to users.

Therefore, it is necessary to set an optimum reference value 230 according to the level of security required.

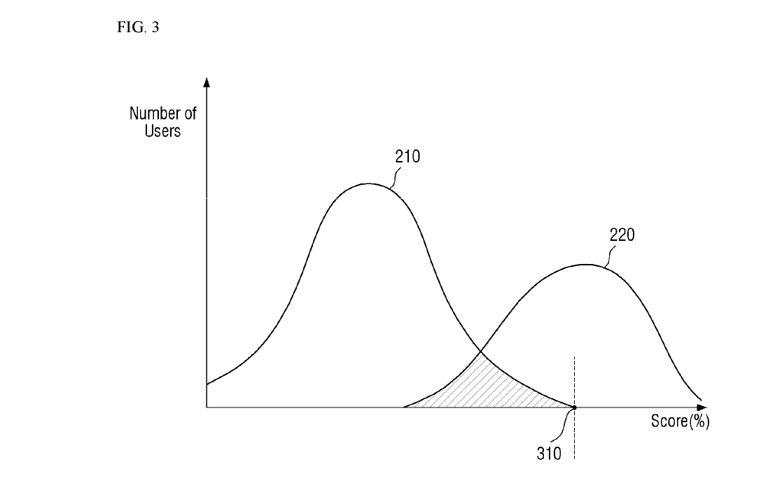

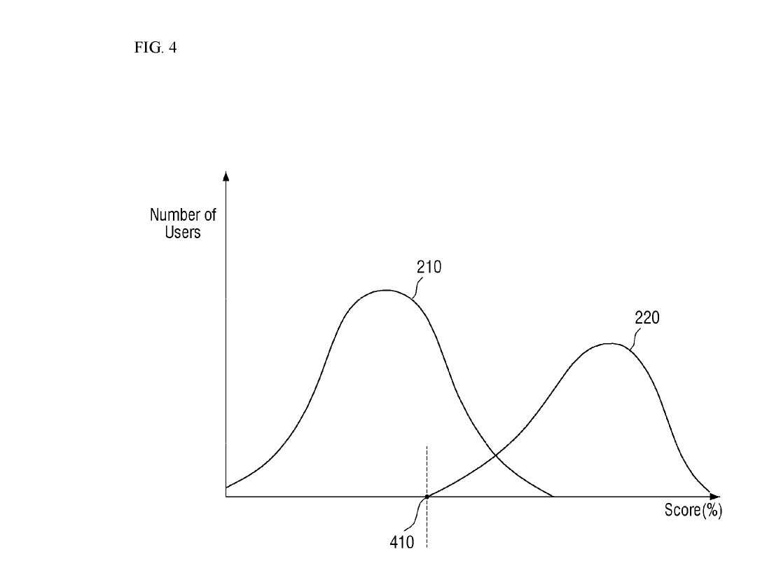

FIGS. 3 and 4 illustrate a process of setting a first reference value and a second reference value corresponding to a first security level according to an embodiment.

A case where first biometric information is a user's fingerprint information and second biometric information is the user's iris information will hereinafter be described as an example. However, the biometric information that can be used for user authentication is not limited to the fingerprint information and the iris information.

A user authentication system using biometric information is used primarily for security. Therefore, if the user authentication system wrongly determines biometric information of an unauthenticated user to be biometric information of an authenticated user, detrimental results may occur. For this reason, a performance index of the user authentication system using biometric information is generally determined to be the FRR when the FAR is 0%.

However, as the FAR becomes closer to 0%, the FRR increases, thus reducing the convenience of users.

Therefore, there is a need for a user authentication method which can improve the convenience of users by reducing the FRR while minimizing the FAR for content or transactions that require top-level security.

In this regard, in the method of authenticating a user using a plurality of biometric information according to the embodiment, if a security level is set to a first security level, a first reference value 310 used to determine whether the first biometric information matches pre-stored first reference biometric information of a user may be set to a similarity score when the FAR is 0. Specifically, the first reference value 310 may be set to a value at a location illustrated in FIG. 3.

Here, the first reference value 310 is a value used to determine whether a user's first biometric information (e.g., fingerprint information) input through a sensor matches first reference biometric information registered in advance by the user.

If the first reference value 310 is set to a similarity score when the FRR is 0 according to an embodiment, security may be increased. However, the FAR may also be increased. Therefore, the second biometric information is used to reduce the FAR.

Specifically, a second reference value 410 used to determine whether the second biometric information matches pre-stored second reference biometric information of the user may be set to a similarity score when the FAR is 0, as illustrated in FIG. 4.

Using the first reference value 310 and the second reference value 410 described above, user authentication may be performed as follows.

Since the first reference value 310 was set to a similarity score when the FAR was 0, it is hardly likely for an unregistered user's fingerprint (i.e., the first biometric information) to be determined to be a registered user's fingerprint.

On the other hand, if the first biometric information whose first reference value 310 was set to a similarity score when the FAR was 0 is used, the probability that a registered user will be rejected increases. Therefore, the second biometric information whose second reference value 410 was set to a similarity score when the FRR was 0 is used to reduce the FRR.

Specifically, even when a user is determined to be not a registered user because the similarity between the first biometric information and the first reference biometric information is smaller than the first reference value 310, if the similarity between the second biometric information and the second reference biometric information is equal to or greater than the second reference value 410, user authentication is accepted.

That is, the first biometric information whose reference value was set to a similarity score when the FRR was 0 is used to prevent attempts for user authentication by unregistered users, and the second biometric information whose reference value was set to a similarity score when the FRR was 0 is used to prevent a registered user from being determined to be an unregistered user.

As described above, if user authentication is performed using a plurality of pieces of biometric information having different reference values, the FRR can be reduced while the FAR is minimized. This cannot only strengthen security but also improve user convenience.

If the similarity between the first biometric information and the first reference biometric information is smaller than the first reference value 310 and if the similarity between the second biometric information and the second reference biometric information is smaller than the second reference value 410, user authentication is rejected.

This is because input biometric information is highly likely to be biometric information of an unregistered user if the similarity between the first biometric information and the first reference biometric information is smaller than the first reference value 310 and if the similarity between the second biometric information and the second reference biometric information is smaller than the second reference value 410.

When high security is not required, it may be required to improve user convenience by minimizing the FRR.

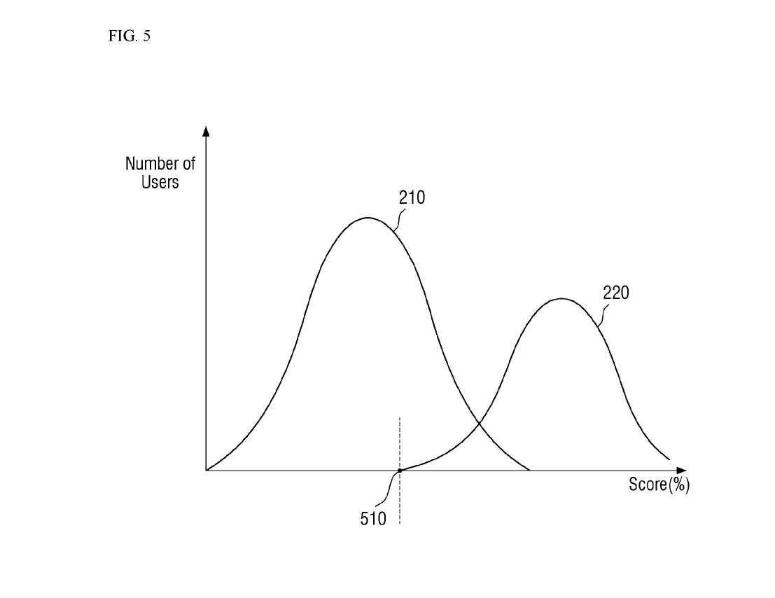

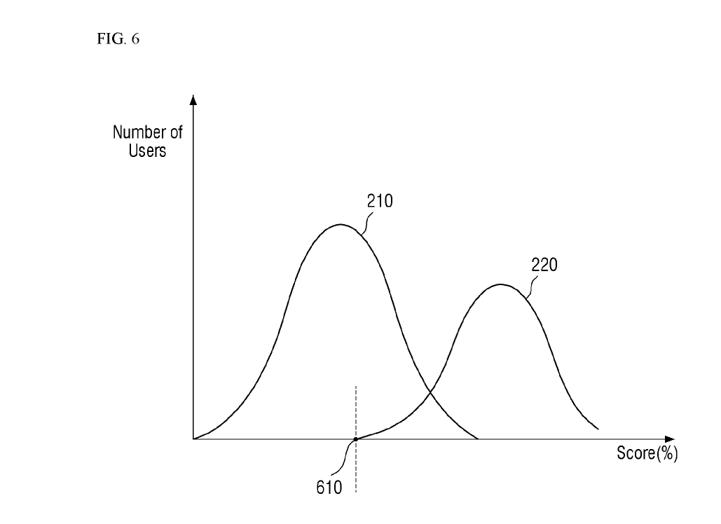

FIGS. 5 and 6 illustrate a process of setting a first reference value and a second reference value corresponding to a second security level according to an embodiment.

User authentication using a user's biometric information can be performed according to a one-to-one (1:1) matching method in which a particular user's biometric information is registered in advance and compared with input biometric information to determine whether the input biometric information matches the pre-registered biometric information and a one-to-N (1:N) matching method in which a plurality of biometric information of unspecified users are searched to find biometric information that matches a user's biometric information input through a sensor.

A representative example of the 1:1 matching method is an unlocking function of a smartphone using biometric information. When a smartphone has an unlocking function, biometric information of a user of the smartphone is registered in advance, and biometric information input through a sensor included in the smartphone is compared with the pre-registered biometric information. If the similarity between the input biometric information and the pre-registered biometric information is equal to or greater than a preset threshold value, it is determined that the input biometric information is from the authenticated user.

In the 1:1 matching method, there is a low probability that an unregistered user whose biometric information has very high similarity to biometric information of a registered user will attempt user authentication. Therefore, reducing the FRR instead of the FAR may improve user convenience.

In this regard, in the user authentication method according to the embodiment, when the security level is set to a second security level which is not as high as the security level required in the 1:1 matching method, reference values may be set as follows to reduce the FRR and prevent an increase in the FAR.

Specifically, when an input for setting the security level to the second security level is received, a first reference value 510 may be set to a similarity score when the FRR is 0 as illustrated in FIG. 5.

As described above, the first reference value 510 is a value used to determine whether a user's first biometric information (e.g., fingerprint information) input through a sensor matches first reference biometric information registered in advance by the user.

In addition, a second reference value 610 used to determine whether second biometric information input through a sensor matches pre-stored second reference biometric information is set to a similarity score when the FRR is 0.

The second reference value 610 is also a value used to determine whether a user's second biometric information (e.g., iris information) input through a sensor matches second reference biometric information registered in advance by the user.

Using the first reference value 510 and the second reference value 610 described above, user authentication may be performed as follows.

If the similarity between the first biometric information and the pre-registered first reference biometric information is equal to or greater than the first reference value 510 or if the similarity between the second biometric information and the pre-registered first reference biometric information is equal to or greater than the second reference value 610, user authentication is accepted.

That is, if the similarity between at least any one of the first biometric information and the second biometric information and pre-registered reference biometric information is equal to or greater than a reference value, user authentication is accepted.

On the other hand, if the similarity between the first biometric information and the pre-registered first reference biometric information and the similarity between the second biometric information and the pre-registered second reference biometric information are smaller than the first reference value and the second reference value, respectively, user authentication is rejected.

Generally, the probability that a plurality of biometric information of an unregistered user will all match a plurality of biometric information of a registered user is very low.

For example, when a first user is a registered user and a second user is an unregistered user, the probability both that the similarity between the first user's fingerprint information and the second user's fingerprint information will be located between a similarity score when the FRR is 0 and a similarity score when the FAR is 0 and that the similarity between the first user's iris information and the second user's iris information will be located between a similarity score when the FRR is 0 and a similarity score when the FAR is 0 may be very low.

Therefore, as in the above-described embodiment, a plurality of biometric information may be used, and a reference value for each of the biometric information may be set to a value when the FAR is 0. Then, user authentication may be accepted when a similarity score of at least one of the pieces of biometric information is greater than the reference value. In this way, it is possible to prevent an increase in the FAR while minimizing the FRR.

In the above-described embodiment, a case where user authentication is performed by changing a reference value according to a security level has been described as an example. However, other methods can also be used for user authentication.

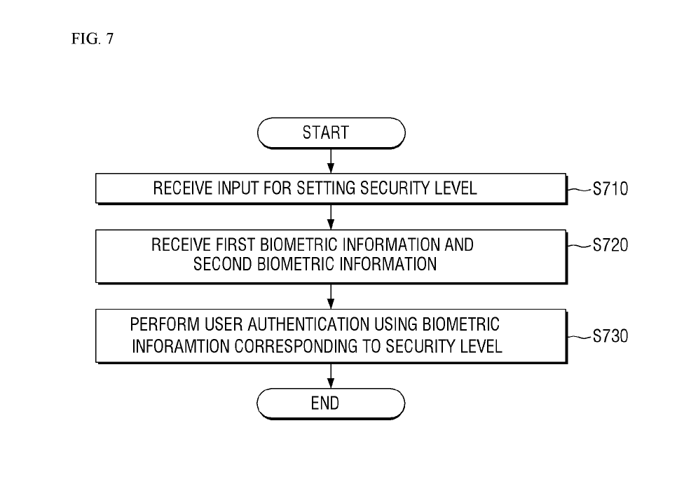

FIG. 7 is a flowchart illustrating a method of authenticating a user using a plurality of biometric information according to an embodiment.

In the user authentication method according to the embodiment, a plurality of biometric information may be received from a user, and biometric information to be used for user authentication may be selected according to a preset security level.

The security of a security system using biometric information may vary according to characteristics of the biometric information. For example, fingerprints typically used for biometric information authentication have an FRR of 0.1 to 0.5% and an FAR of 0.001 to 0.01%. On the other hand, irises recently widely used for user authentication have an FRR of 0.0001 to 0.1% and an FAR of 0.000083 to 0.0001%. Therefore, irises provide higher security than fingerprints.

Accordingly, a user can increase user convenience by selecting biometric information to be used for user authentication according to a preset security level.

To this end, in the user authentication method according to the embodiment, an input for setting a security level is received (operation S710). Security levels according to an embodiment may include a third security level which requires highest-level security, a fourth security level which requires lowest-level security, and a fifth security level which is between the third security level and the fourth security level.

Next, first biometric information and second biometric information necessary for user authentication are received (operation S720). Here, the first biometric information may be fingerprint information, and the second biometric information may be iris information. However, other biometric information can also be received.

After the first biometric information and the second biometric information are received, at least one of the first biometric information and the second biometric information which corresponds to a security level set by a user is compared with pre-registered reference biometric information. If a similarity score between the at least one of the first biometric information and the second biometric information and the pre-registered reference biometric information is equal to or greater than a preset reference value, user authentication is accepted (operation S730).

A process of authenticating a user using at least one piece of biometric information according to a security level will now be described in detail.

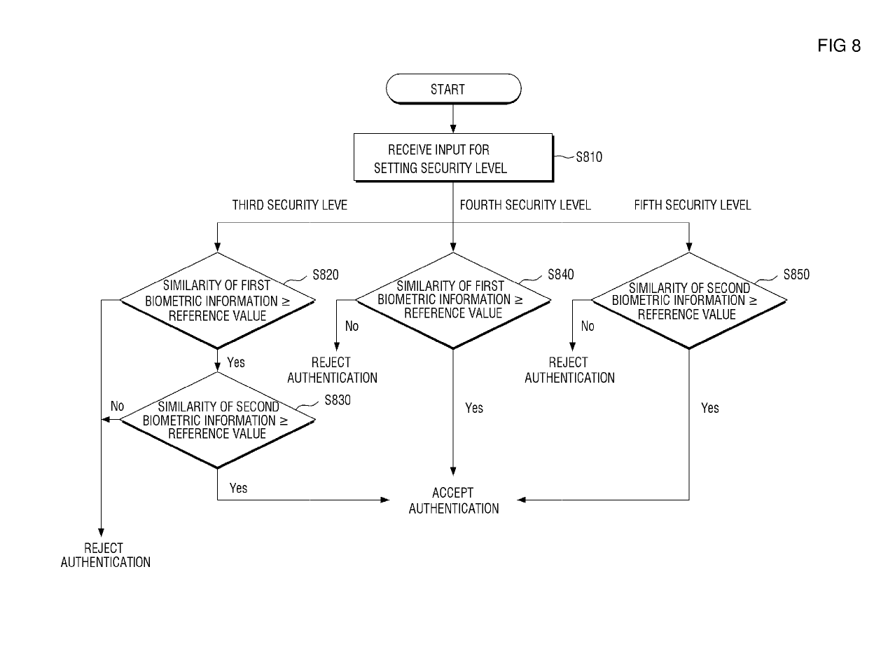

FIG. 8 is a flowchart illustrating a process of authenticating a user using biometric information based on a security level set by a user according to an embodiment.

First, an input for setting a security level is received from a user (operation S810). Here, the security level is a relative concept compared with other security levels. For example, a third security level may be a highest security level, and a fourth security level may be lower than a fifth security level.

That is, the security levels described below may be higher in order of the third security level->the fifth security level->the fourth security level.

Here, the third security level is a security level at which highest security is required.

When the security level is the third security level, it is determined whether the similarity between first biometric information and first reference biometric information is equal to or greater than a preset reference value (operation S820). If the similarity is smaller than the preset reference value, user authentication is rejected. If the similarity is equal to or greater than the preset reference value, it is determined whether the similarity between second biometric information and second reference biometric information is equal to or greater than a preset reference value (operation S830).

That is, if the security level is set to the third security level at which highest security is required, user authentication is performed only when the similarity scores between both of two pieces of biometric information and corresponding pre-registered reference biometric information are equal to or greater than corresponding preset reference values, respectively.

Next, the fourth security level is a security level at which lowest security is required.

When the security level is the fourth security level, the similarity between the first biometric information and the first reference biometric information is determined (operation S840). If the similarity is equal to or greater than a preset reference value, user authentication is accepted regardless of the similarity score between the second biometric information and the second reference biometric information.

Here, the first biometric information may be fingerprint information, and the second biometric information may be iris information. While the fingerprint information provides less security than the iris information, its high recognition rate and low error rate contribute to user convenience. Therefore, when the security level is set to the lowest level, only the fingerprint information is used to perform user authentication.

Lastly, when the security level is the fifth security level which is lower than the highest level and higher than the lowest level, the similarity between the second biometric information and the second reference biometric information is determined (operation S850). If the similarity score between the second biometric information and the second reference biometric information is equal to or greater than a preset reference value, user authentication is accepted regardless of the similarity score between the first biometric information and the first reference biometric information.

Here, the first biometric information may also be fingerprint information, and the second biometric information may also be iris information.

As described above, biometric information used for user authentication may be changed according to a security level, thereby improving user convenience and providing optimum security.

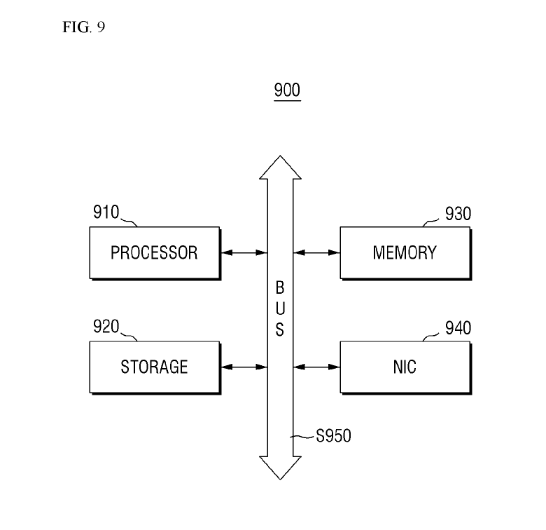

FIG. 9 is a functional block diagram of an apparatus for authenticating a user using a plurality of biometric information according to an embodiment.

A user terminal 900 according to an embodiment includes a processor 910, a storage device 920, a memory 930, a network interface card (NIC) 940, and a bus 950. In FIG. 9, elements related only to the current embodiment are illustrated. However, those of ordinary skill in the art to which the inventive concept pertains will understand that general-purpose elements other than the elements illustrated in FIG. 9 can further be included in the user terminal 900.

The processor 910 may execute a program for authenticating a user using a plurality of biometric information. However, the processor 910 may also be implemented to execute other programs.

The storage device 920 stores an execution file and other resource files of the program for authenticating a user using a plurality of biometric information. The program for authenticating a user using a plurality of biometric information according to an embodiment may execute an operation of receiving an input for setting a security level, an operation of setting a first reference value used to determine whether first biometric information of a user matches pre-stored first reference biometric information of the user to a value corresponding to the security level, an operation of setting a second reference value used to determine whether second biometric information of the user matches pre-stored second reference biometric information of the user to a value corresponding to the security level, an operation of receiving the first biometric information and the second biometric information of the user, and an operation of authenticating the user using the similarity between the first biometric information and the first reference biometric information and the similarity between the second biometric information and the second reference biometric information.

The memory 930 is loaded with the program for authenticating a user using a plurality of biometric information. The program for authenticating a user using a plurality of biometric information loaded in the memory 930 is executed by the processor 910.

Other computing devices may be connected to the NIC 940, and the bus 950 may be connected to the processor 910, the storage device 920, the memory 930, etc. to serve as a data transmitting path.

As described above, a method of authenticating a user using a plurality of biometric information can ensure optimum security while improving user convenience.

In addition, it is possible to reduce an error rate by minimizing the FAR and the FRR, thereby improving user convenience.

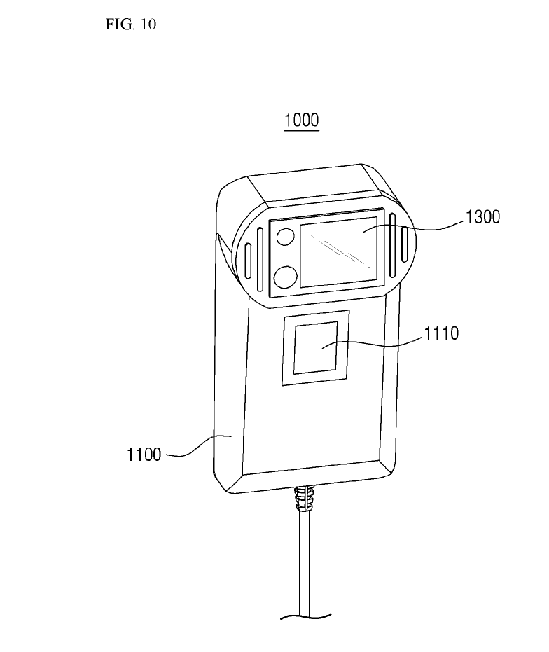

FIG. 10 illustrates a user authentication apparatus using a plurality of biometric information according to an exemplary embodiment of the present disclosure.

Referring to FIG. 10, a user authentication apparatus 1000 includes a gripping unit 1100, an iris recognition unit 1300, and a control unit (not illustrated).

FIG. 10 illustrates only elements that are relevant to the present exemplary embodiment. Thus, it should be understood that the user authentication apparatus 1000 may include various general-purpose elements other than those illustrated in FIG. 10.

The gripping unit 1100 is bar-shaped and allows a user to grip the user authentication apparatus 1000. FIG. 10 illustrates the gripping unit 1100 as being bar-shaped, but the shape of the gripping unit 1100 is not particularly limited. That is, the gripping unit 1100 may be implemented in various other general-purpose shapes that allow the user to grip the user authentication apparatus 1000.

The gripping unit 1100 includes a fingerprint scanner 1110. The fingerprint scanner 1110 may be implemented as a capacitive array sensor acquiring an image of a fingerprint in contact with a silicon chip by use of a silicon chip, an optical array sensor acquiring an image of a fingerprint by use of total reflection of light incident upon a prism from a light source, a thermal array sensor acquiring an image of a fingerprint using a difference in temperature by measuring the temperature of a finger, a charge-coupled device (CCD)/complementary metal-oxide-semiconductor (CMOS) sensor acquiring an image of a fingerprint by use of a CCD/CMOS sensor, an ultrasonic sensor acquiring an image of a fingerprint by projecting ultrasonic waves onto a finger placed at a contact surface so as to convert acoustic waves reflected from the finger into electrical signals, or a tactile sensor converting an image of part of a finger in contact into a digital image, but the present disclosure is not limited thereto. That is, various other general-purpose sensors may be used.

The iris recognition unit 1300 is provided at the top of the gripping unit 1100 and may include elements for obtaining an image of an iris of the user, such as an induction mirror, an infrared (IR) light-emitting diode (LED) light source device, and a camera.

In response to an eye of the user being placed within a predetermined distance from the iris recognition unit 1300, the IR LED light source device applies IR rays to the eye, and light reflected from the eye is captured by the camera, thereby acquiring an image of the iris.

The control unit performs user authentication using at least one biometric information selected from between fingerprint information acquired by the fingerprint scanner 1110 and iris information acquired by the iris recognition unit 1300.

The expression “performing user authentication”, as used herein, may mean transmitting acquired biometric information to an electronic device with a fingerprint recognition algorithm or an iris recognition algorithm stored therein and having the electronic device compare the acquired biometric information with previously-registered user biometric information. Alternatively, the expression “performing user authentication”, as used herein, may also mean performing user authentication using a fingerprint recognition algorithm or an iris recognition algorithm present in the user authentication apparatus 1000.

As mentioned above, if multiple biometric recognition sensors are provided in a single user authentication apparatus 1000, multiple biometric information can be acquired at the same time, and thus, user convenience can be improved.

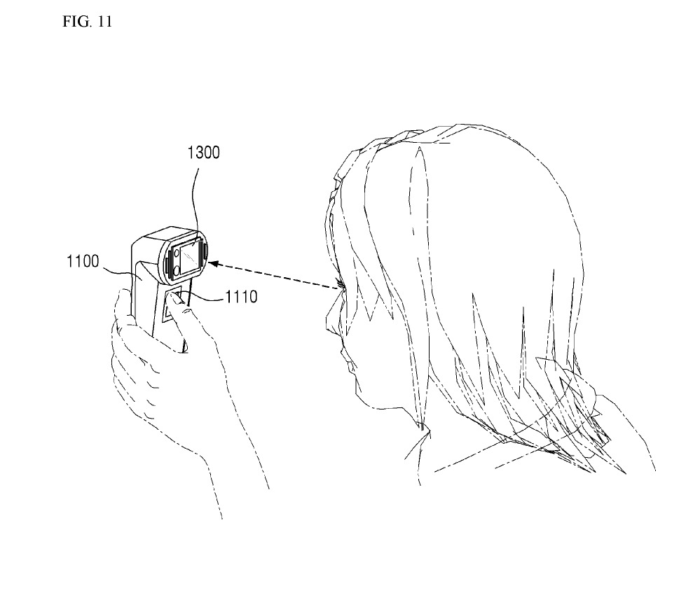

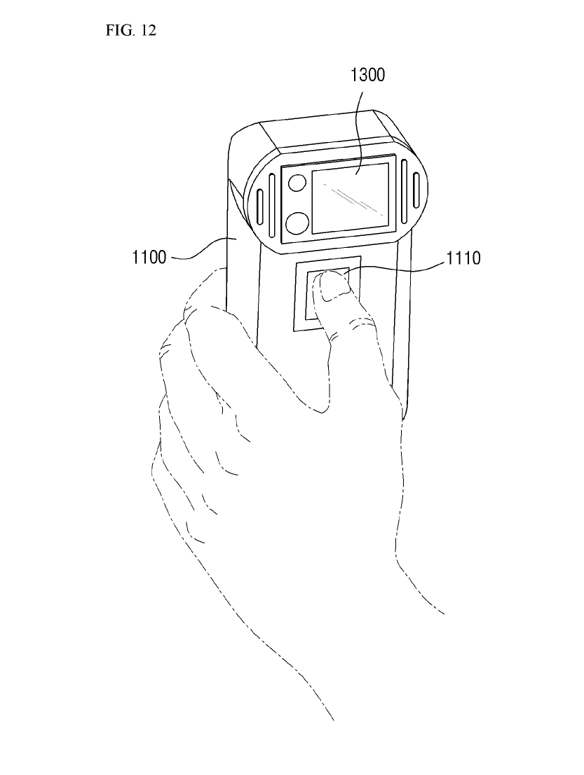

FIGS. 11 and 12 illustrate acquiring multiple biometric information by a user authentication apparatus using a plurality of biometric information according to an exemplary embodiment of the present disclosure.

In order for the user to have an image of his or her iris captured, the user is required to place the user authentication apparatus 1000, which is equipped with the iris recognition unit 1300, as illustrated in FIG. 11, near his or her eye while gripping the user authentication apparatus 1000.

The fingerprint scanner 1110 may face the same direction as a direction in which the camera of the iris recognition unit 1300 captures an image of the user's iris and may be provided on a surface that is to be in contact with a thumb of the user.

Thus, in response to the user gripping the gripping unit 1100 to have an image of his or her iris captured, the end of the user's thumb may be placed in contact with the fingerprint scanner 1110, as illustrated in FIG. 12. As a result, the fingerprint scanner 1110 may acquire fingerprint information from the user's thumb.

Therefore, a plurality of biometric information can be transmitted via a single user authentication apparatus 1000 without the need to transmit fingerprint information and iris information via an additional user authentication apparatus for user authentication, and thus, user convenience can be improved.

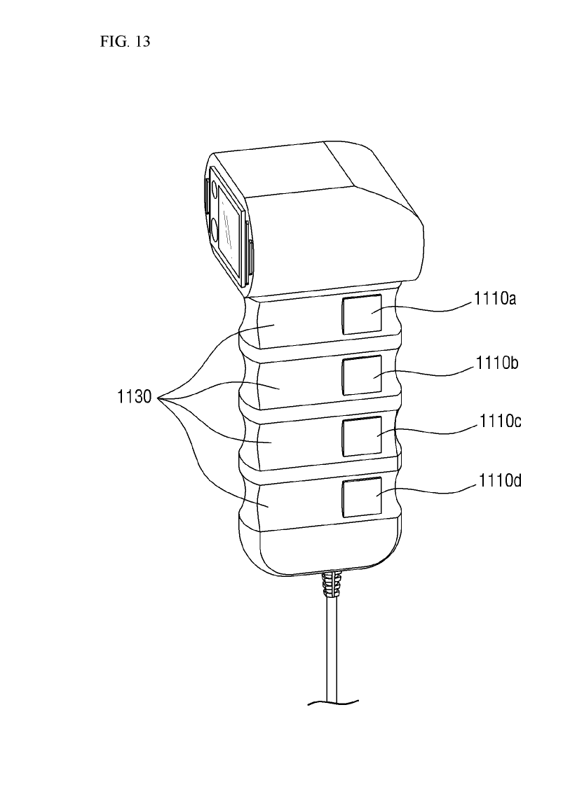

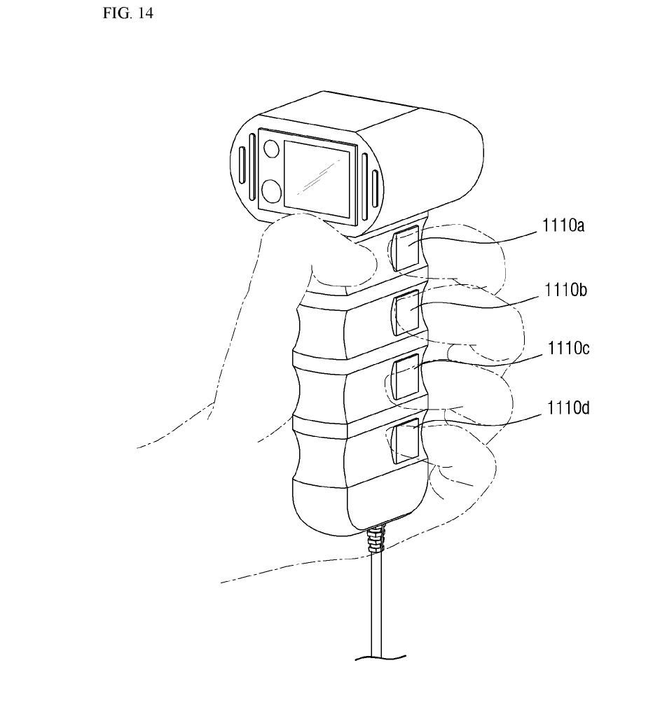

FIGS. 13 and 14 illustrate a user authentication apparatus using a plurality of biometric information according to another exemplary embodiment of the present disclosure.

Referring to FIGS. 13 and 14, one or more guide grooves 1130, which can receive the user's fingers therein, may be formed in the gripping unit 1100. For example, four guide grooves 1130 may be formed to accommodate all the fingers on one hand except for the thumb.

In response to the user placing four fingers of his or hers in the guide grooves 1130 to grip the gripping unit 1100, the iris recognition unit 1300 may face the user's face and may thus be able to capture an image of the user's iris with ease.

In at least one of the guide grooves 1130, the fingerprint scanner 1110a˜1110d may be provided on a surface that is to be in contact with a finger of the user. More specifically, the fingerprint scanners 1110a˜1110d may be installed in each of the guide grooves 1130, as illustrated in FIG. 13, or may be installed only in a guide groove 1130 to be in contact with the index finger.

As mentioned above, by using the guide grooves 1130, the user's grip of the user authentication apparatus 1000 can be improved, and thus, user satisfaction can be enhanced. Also, the user's fingers can be naturally placed in contact with the fingerprint scanners 1110a˜1110d, and thus, error rate can be lowered.

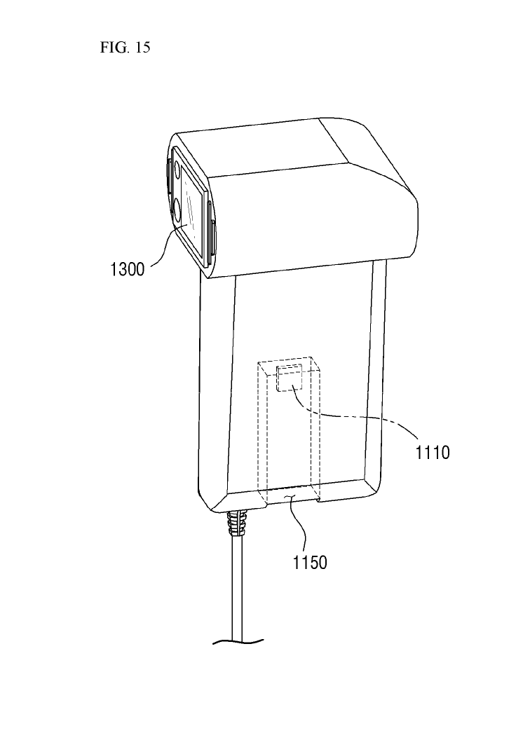

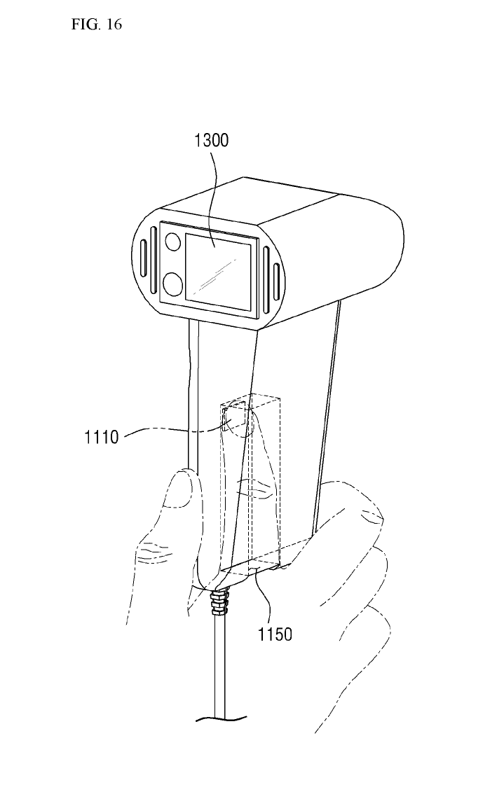

FIGS. 15 and 16 illustrate a user authentication apparatus using a plurality of biometric information according to another exemplary embodiment of the present disclosure.

Referring to FIG. 15, the gripping unit 1100 may include a receiving groove 1150, which is formed at the bottom of the gripping unit 1100. The fingerprint scanner 1110 may be provided on an inner side of the receiving groove 1150.

Referring to FIG. 16, in response to the user placing the iris recognition unit 1300 near his or her eye with his or her finger inserted in the receiving groove 1150, the fingerprint scanner 1110, which is provided on the inner side of the receiving groove 1150, may acquire fingerprint information from the user.

FIG. 16 illustrates the user as being allowed to insert only one finger of his or hers into the receiving groove 1150, but the receiving groove 1150 may be configured to accommodate more than one finger of the user.

The receiving groove 1150 may be provided not only at the bottom of the gripping unit 1100, but also on a side, or at the front, of the gripping unit 1100.

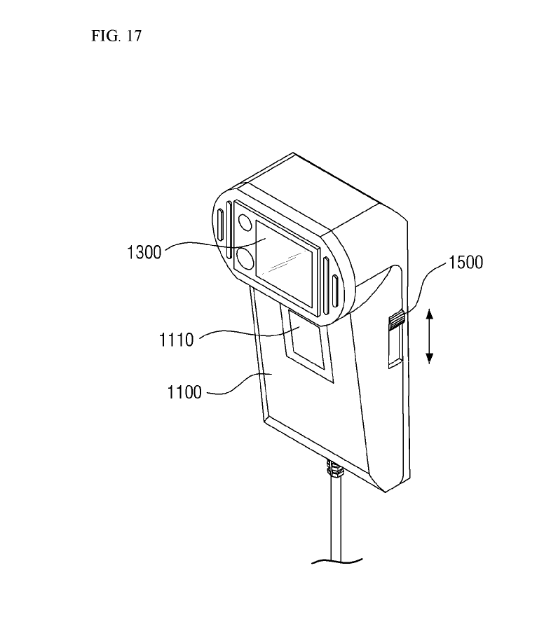

FIG. 17 illustrates a user authentication method according to an exemplary embodiment of the present disclosure, in which a security level is set and biometric information to be used in user authentication is chosen according to the set security level.

The user authentication apparatus may further include a switching unit 1500, which can set a security level.

The level of security of a security system using biometric information may vary depending on the characteristics of the biometric information used. For example, fingerprint recognition, which is one of the most representative biometric authentication methods, has a false rejection rate of 0.1% to 0.5% and a false acceptance rate of 0.001% to 0.01%. On the other hand, iris recognition, which is recently of increasing use in user authentication, has a false rejection rate of 0.0001% to 0.1% and a false acceptance rate of 0.000083% to 0.0001% and is thus considered securer than fingerprint recognition.

Accordingly, user convenience may be improved by allowing the user to choose biometric information to be used in user authentication according to a predefined security level.

The term “security level”, as used herein, may be a relative concept. For example, a first security level may be a highest security level, and a second security level may be a security level lower than the first security level, but higher than a third security level, which is a lowest security level.

That is, the level of security may be lowered from the first security level to the second security level to the third security level.

The control unit may generate a control signal that activates at least one of the iris recognition unit 1300 and the fingerprint scanner 1110 according to a security level to which the switching unit 1500 is set.

For example, in a case in which the switching unit 1500 is set to the first security level, which requires a highest level of security, the control unit activates both the fingerprint scanner 1110 and an iris scanner included in the iris recognition unit 1300 to acquire both fingerprint information and iris information from the user.

Acquired biometric information may be transmitted to another electronic device to be used in user authentication, or may be used in the user authentication apparatus 1000 to perform user authentication based on a fingerprint recognition algorithm and an iris recognition algorithm present in the user authentication apparatus 1000.

In a case in which the switching unit 1500 is set to the second security level, which is lower than the first security level requiring the highest level of security, but higher than the third security level requiring a lowest level of security, the control unit may activate only the iris recognition unit 1300 to acquire only iris information from the user.

In general, a user authentication method using iris information is considered securer than a user authentication method using fingerprint information. Thus, in a case in which the switching unit 1500 is set to the second security level, a control signal activating only the iris recognition unit 1300 is generated so as to perform user authentication based solely on iris information.

In a case in which the switching unit 1500 is set to the third security level requiring the lowest level of security, the control unit may generate a control signal activating only the fingerprint scanner 1110.

A user authentication method using fingerprint information has a relatively low level of security, but has low error rate and high recognition speed. Thus, in response to the switching unit 1500 being set to the third security level, only the fingerprint scanner 1110 may be activated to acquire fingerprint information, and user authentication may be performed based on the fingerprint information.

As mentioned above, by using different biometric information in user authentication depending on the operation of the switching unit 1500, an optimum level of security can be provided, and error rate can be lowered so as to improve user convenience.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of authenticating a user using a plurality of biometric information, the method comprising:
receiving an input for setting a security level;
setting a first reference value used to determine whether first biometric information of a user matches pre-stored first reference biometric information of the user to a value corresponding to the security level;
setting a second reference value used to determine whether second biometric information of the user matches pre-stored second reference biometric information of the user to a value corresponding to the security level;
receiving the first biometric information and the second biometric information of the user; and
authenticating the user using the similarity between the first biometric information and the first reference biometric information and the similarity between the second biometric information and the second reference biometric information.

2. The method of claim 1, wherein when the security level is a first security level, the setting of the first reference value to the value corresponding to the security level comprises setting the first reference value to a similarity score when a false acceptance ratio (FAR) is 0, and the setting of the second reference value to the value corresponding to the security level comprises setting the second reference value to a similarity score when a false rejection ratio (FRR) is 0.

3. The method of claim 2, wherein the authenticating of the user comprises accepting to authenticate the user when the similarity between the second biometric information and the second reference biometric information is equal to or greater than the second reference value even if the similarity between the first biometric information and the first reference biometric information is smaller than the first reference value.

4. The method of claim 2, wherein the authenticating of the user comprises rejecting to authenticate the user when the similarity between the first biometric information and the first reference biometric information is smaller than the first reference value and when the similarity between the second biometric information and the second reference biometric information is smaller than the second reference value.

5. The method of claim 1, wherein when the security level is a second security level, the setting of the first reference value to the value corresponding to the security level comprises setting the first reference value to a similarity score when the FAR is 0, and the setting of the second reference value to the value corresponding to the security level comprises setting the second reference value to a similarity score when the FRR is 0.

6. The method of claim 5, wherein the authenticating of the user comprises accepting to authenticate the user when the similarity between the first biometric information and the first reference biometric information is equal to or greater than the first reference value or when the similarity between the second biometric information and the second reference biometric information is equal to or greater than the second reference value.

7. The method of claim 5, wherein the authenticating of the user comprises rejecting to authenticate the user when the similarity between the first biometric information and the first reference biometric information is smaller than the first reference value and when the similarity between the second biometric information and the second reference biometric information is smaller than the second reference value.

8. A method of authenticating a user using a plurality of biometric information, the method comprising:
receiving an input for setting a security level;
receiving first biometric information and second biometric information of a user; and
comparing at least one of the first biometric information and the second biometric information which corresponds to the security level with pre-registered reference biometric information and accepting to authenticate the user when a similarity score between the at least one of the first biometric information and the second biometric information and the pre-registered reference biometric information is equal to or greater than a preset reference value.

9. The method of claim 8, wherein when the security level is a third security level which is a highest security level, the accepting to authenticate the user comprises accepting to authenticate the user when the similarity between the first biometric information and first reference biometric information is equal to or greater than a preset reference value and when the similarity between the second biometric information and second reference biometric information is equal to or greater than a preset reference value.

10. The method of claim 8, wherein when the security level is a fourth security level which is a lowest security level, the accepting to authenticate the user comprises accepting to authenticate the user when the similarity between the first biometric information and the first reference biometric information is equal to or greater than the preset reference value regardless of the similarity score between the second biometric information and the second reference biometric information.

11. The method of claim 10, wherein the first biometric information is fingerprint information, and the second biometric information is iris information.

12. The method of claim 8, wherein when the security level is a fifth security level which is lower than the highest security level and higher than the lowest security level, the accepting to authenticate the user comprises accepting to authenticate the user when the similarity between the second biometric information and the second reference biometric information is equal to or greater than the preset reference value regardless of the similarity score between the first biometric information and the first reference biometric information.

13. The method of claim 12, wherein the first biometric information is fingerprint information, and the second biometric information is iris information.
